(19) United States
(12) Patent Application Publication
(10) Pub. No.: US 2011/0097651 A1
(43) Pub. Date: Apr. 28, 2011

(54) Membrane Electrode Assembly (MEA) Fabrication Procedure on Polymer Electrolyte Membrane Fuel Cell

(75) Inventors: Sung-Dae Yim, Yuseong-gu (KR); Seok-Hee Park, Yuseong-gu (KR); Gu-Gon Park, Yuseong-gu (KR); Young-Jun Sohn, Yuseong-gu (KR); Minjin Kim, Yuseong-gu (KR); Tae-Hyun Yang, Yuseong-gu (KR); Young-Gi Yoon, Seo-gu (KR); Chang-Soo Kim, Jung-gu (KR); Won-Yong Lee, Yuseong-gu (KR)

(73) Assignee: KOREA INSTITUTE OF ENERGY RESEARCH, Daejeon (KR)

(21) Appl. No.: 12/887,113

(22) Filed: Sep. 21, 2010

(30) Foreign Application Priority Data
Oct. 22, 2009 (KR) 10-2009-0100647

(51) Int. Cl. H01M 8/10

(52) U.S. Cl. 429/535

(57) ABSTRACT

Provided is a method for fabricating membrane electrode assembly (MEA) on a polymer electrolyte membrane fuel cell. The method includes adhering or fixing the first backing film to a polymer electrolyte membrane; forming a first catalyst layer on the polymer electrolyte membrane; removing the first backing film; adhering or fixing the second backing film to the first catalyst layer formed on the surface of the polymer electrolyte membrane; forming the second catalyst layer on the other side of the polymer electrolyte membrane; and removing the second backing film to complete the MEA.

### CROSS-REFERENCE TO RELATED APPLICATIONS

This application claims priority under 35 U.S.C. §119 to Korean Patent Application No. 10-2009-0100647, filed on Oct. 22, 2009, in the Korean Intellectual Property Office, the disclosure of which is incorporated herein by reference in its entirety.

### TECHNICAL FIELD

The following disclosure relates to a method for fabricating membrane electrode assembly (MEA) on a polymer electrolyte membrane fuel cell, and in particular, to an MEA fabricating method for a polymer electrolyte membrane fuel cell manufactured by directly coating catalyst layers to a polymer electrolyte membrane using a backing film.

### BACKGROUND

A fuel cell is a kind of a power generation device as a battery directly converting chemical energy produced by oxidation of fuel into electrical energy. The fuel cell is the same as a normal chemical cell in a point that an oxidation-reduction reaction is used. However, the fuel cell is a device that a reaction product is continuously removed outside a system because the reactant is continuously supplied from the outside, unlike a chemical cell that performs cell reaction inside a closed system. A typical one is a hydrogen-oxygen fuel cell.

The fuel cell has higher efficiency than a traditional internal-combustion engine, generates fewer emissions of nitrogen oxides and sulphite oxides, which cause air pollution. Additionally, the fuel cell has big effects on environmental conservation because it can largely reduce emissions of carbon dioxide. Also, since the fuel cell uses hydrogen and oxygen contained inside hydrocarbon based materials like methanol, ethanol and natural gas, the use of various fuels is possible, and there is almost no noise or vibration.

The fuel cell has a structure of enclosing electrolyte with two electrodes and is divided into polymer electrolyte membrane fuel cell (PEFC or proton exchange), alkaline fuel cell (PAFC), Molten carbonate fuel cell (MCFC), and solid oxide fuel cell (SOFC) according to a type of the electrolytes. As representative examples, there are Polymer Electrolyte Membrane Fuel Cell (PEMFC) and Direct Methanol Fuel Cell (DMFC).

As the polymer electrolyte fuel cell (PEMFC) has high output density and energy efficiency, is operated in normal temperature, and is simple in a configuration of devices, it can be widely used as a home power generation system, a power supply of mobile communication devices and an automobile power source, etc.

A membrane electrode assembly (MEA) is positioned at the center of the polymer electrolyte fuel cell, and an anode, which is also called “fuel pole”, and a cathode, which is also called “Air pole” or “oxygen pole”, of the MEA are positioned in both surfaces of the polymer electrode membrane. The MEA is manufactured to form a catalyst layer between two poles by coating and drying electrode catalyst slurry to the polymer electrolyte membrane.

A principle of the polymer electrolyte fuel cell is to generate hydrogen ions and electrons by being adsorbed and oxidized at a catalyst layer after the fuel is supplied to the anode. The electrons generated at this time reach the cathode as an oxidation pole along an external circuit, and the hydrogen ions are delivered to the cathode through a polymer electrolyte membrane. An oxidizer is supplied to the cathode, and electricity is generated by generating water through reaction of the hydrogen ions and electrons on the catalyst of the cathode.

The technology for performance improvement of a polymer electrolyte fuel cell needs the fuel cell material technology, such as the catalyst fabricating technology that generates oxidation of hydrogen and reduction of oxygen, the ion-conductive polymer membrane fabricating technology that delivers cations being generated by oxidation of hydrogen to the reduction electrode, and the gas diffusion layer and supporter fabricating technology that supports a catalyst layer and helps smooth delivery of supplied gas at the same time. The MEA fabricating technology among them has important influence on performance of a fuel cell.

There are a catalyst coated diffusion layer (CCD) method of coating a catalyst to a gas diffusion layer, and a catalyst coated membrane (CCM) method of directly coating a catalyst to an electrolyte membrane as a MEA fabricating method. In case of CCD that is being generally used much, the catalyst slurry is made by mixing a catalyst and Nafion ionomer, and after this is evenly coated to porous carbon paper or carbon cloth, an electrode is installed to both sides of the electrolyte membrane and then is manufactured by hot-pressing. On the other hand, the CCM is manufactured by a direct coating method of coating catalyst slurry containing Nafion ionomer to an electrolyte membrane or a transfer method of transferring an electrode coated to a transfer film like Teflon, etc. to the electrolyte membrane.

Since the catalyst slurry is directly coated to the electrolyte membrane in the direct coating method, swelling occurs by contacting of the solvent in catalyst slurry with the electrolyte membrane and the shape and size of the electrolyte membrane are changed to cause difficulties in its fabricating. Accordingly, a spray coating method is generally used, but there are disadvantages such as increases of a lost catalyst amount, a difficult continuous process due to a long fabricating time, and consumption of much cost because it is difficult to remove a solvent and is used after repetitive coating to enhance strength of the catalyst layer.

The transfer method forms a catalyst layer on a release film without deformation in case of contacting with a solvent, puts this on the electrolyte membrane, and transfers the catalyst layer coated on a release film to the electrolyte membrane by hot-pressing, so there is no worry about deformation of the electrolyte membrane, but there are disadvantages that the glass transition temperature of polymer forming the polymer electrolyte membrane is limited because high temperature and pressure are required to perform transfer of the catalyst layer cleanly, that there is a possibility of damage of the catalyst layer due to pressure, and that the interfacial resistance is big because the transfer between the catalyst layer and the membrane reduces a contact area between the two.

Accordingly, the method that directly coats the catalyst slurry to the electrolyte membrane is most ideal to solve these problems and apply it to a continuous process.

### SUMMARY

An embodiment of the present invention is directed to providing a method of fabricating membrane electrode assembly (MEA) that reduces interfacial resistance by increasing a contact area of an electrolyte membrane and a catalyst layer by forming a catalyst layer on both surfaces of a polymer electrolyte membrane according to a direct coating method and that has no deformation of an electrolyte membrane by forming the catalyst layer only after adhering or fixing a backing film to the polymer electrolyte membrane.

In a general aspect, a method for fabricating membrane electrode assembly for polymer electrolyte fuel cell includes:

a) adhering or fixing a polymer electrolyte membrane and a first backing film;
b) forming a first catalyst layer on the polymer electrolyte membrane;
c) removing the first backing film;
d) adhering or fixing the first catalyst layer and a second backing film formed on the polymer electrolyte membrane;
e) forming the second catalyst layer on the polymer electrolyte membrane; and
f) removing the second backing film.

The present invention will be described in detail with reference to the accompanying drawings, which is set forth hereinafter. It is apparent that the following drawings are only examples for detailed description of the present invention and do not limit the scope of the invention.

In the step a), the adhesion of the first backing film 11 and the polymer electrolyte membrane 10 is coating an adhesive to the first backing film 11 and adhering the coated first backing film 11 to electrolyte membrane 10. The adhesive includes acrylic resin, silicone resin, rubber resin, urethane resin, polyester resin or epoxy resin, and any method for coating the backing film in a fixed thickness such as a spray coating method or a bar coating method may be adopted as a method for coating an adhesive to a backing film.

Also, the adhesion is not limited if it is a method that can back the electrolyte membrane with a backing film. Specifically, the adhesion is not limited if the backing film fixed to the electrolyte membrane is a means that facilitates its removal. For example, a means for fixing between the backing film and electrolyte membrane, such as coating of an adhesive or formation of electrostatic force, etc.

The polymer electrolyte membrane 10 may be manufactured by dissolving cation exchange resin in a solvent, and in general, it includes polymer resin with a cation-exchange group selected from a group consisting of a sulfonic acid group, a carboxylic acid group, a phosphate group, a phosphoric acid group in the side-chain and a derivative thereof.

Specific examples of the polymer resin include hydrogen ion conductive polymers selected from a group consisting of fluorine polymer, benzimidazole polymer, polyimide polymer, polyetherimide polymer, polysulfone polymer, polyphenylene sulfide polymer, polyether ketone polymer, a copolymers thereof and a mixture thereof, and preferably, includes any one selected from films made from polyethylene terephthalate, polyimide, polyacrylonitrile, polyvinyl chloride, polytetrafluoroethylene and polyurethane.

The step b) is forming the first catalyst layer on the polymer electrolyte membrane 10, and improves a contact area between the catalyst layer and the electrolyte membrane by using a method of directly coating to the electrolyte membrane, compared to the generally used transfer method as a prior art. Since the backing film contacts the polymer electrolyte membrane in the step a), deformation of the electrolyte membrane due to swelling by a solvent in catalyst slurry generated in case of direct coating may be prevented. A catalyst slurry composition for forming the catalyst layer is prepared by mixing catalyst with a solvent.

Anything to be used as a catalyst in the fuel cell reaction may be used as the catalyst, and the platinum catalyst is generally used. The platinum catalyst includes a catalyst selected from platinum, ruthenium, osmium, platinum-ruthenium alloy, platinum-osmium alloy, platinum-palladium alloy and platinum-M alloy where M is a transition metal selected from a group consisting of Ga, Ti, V, Cr, Mn, Fe, Co, Ni, Cu, Zn, Sn, Mo, W, Rh and a combination thereof. Specific examples of the catalyst include any one selected from a group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Fe/Cr, Pt/Ru/Rh/Ni and Pt/Ru/Sn/W.

Also, the catalyst may be used as a metal catalyst itself and used after being supported at a carrier. Carbon materials such as graphite, denka black, Ketjen Black, acetylene black, carbon nano-tube, carbon nano-fiber or active carbon may be used as a carrier, or inorganic particulates such as alumina, silica, zirconia and titania may be used.

Alcohol solvents such as water, methanol, ethanol, and isopropyl alcohol, or amide solvents such as N-methylpyrrolidone, dimethylformamide, and sulfoxide solvents such as dimethylsulfoxide, may be used as a solvent for mixing or dissolving the catalyst.

A method of forming the first catalyst layer 21 by coating the catalyst slurry composition to a polymer electrolyte membrane 10 may be carried out a method selected from a group consisting of a spray coating method, a screen printing method, a doctor blade method, a gravure coating method, a dip coating method, a silk printing method, a painting method and a slot die method, but the present invention is not limited thereto.

The first formed catalyst layer 21 is obtained by performing hot-pressing on the electrolyte membrane in high temperature and high pressure. The temperature ranges from 100° C. to 200° C., more preferably, from 100° C. to 150° C., and the pressure ranges from 1 kgf/cm² to 15 kgf/cm², more preferably, from 5 kgf/cm² to 10 kgf/cm².

The step c) is a process of removing the first backing film after the first catalyst layer 21 is dried and formed on the polymer electrolyte membrane 10.

The step d) is a process of adhering the first catalyst layer 21 and the second backing film 12 formed on the polymer electrolyte membrane 10, and the second backing film 12 is adhered to the first catalyst layer through a coating method by using an adhesive having the same constituent element as that of the step a).

Also, the adhesion is not limited if it is a method of supporting the polymer electrolyte membrane with a backing film. Specifically, it is not limited if the backing film is a means for facilitating removal of the backing film when the backing film is fixed to the polymer electrolyte membrane.

The step e) is a process of forming the second catalyst layer on the polymer electrolyte membrane 10 formed in the first catalyst layer 21 fixed by the second backing film 12, and is the same as the step b) executed as above.

When the second catalyst layer is dried, the step f) of completing the MEA is performed by removing the second backing film 12.

The first and second backing films use a polymer film selected from a group consisting of polytetrafluoroethylene, tetrafluoroethylene-hexafluoropropylene copolymer, tetrafluoroethylene-perfluoroalkyl vinyl ether copolymer, ethylene/tetrafluoroethylene, polyvinylidene fluoride, polyvinyl chloride, polyamide, polyethylene, polypropylene, polyethylene terephthalate, polyester and copolymers thereof.

Other features and aspects will be apparent from the following detailed description, the drawings, and the claims.

### BRIEF DESCRIPTION OF THE DRAWINGS

FIG. 1 is a method for sequentially fabricating a membrane electrode assembly (MEA) according to an exemplary embodiment.

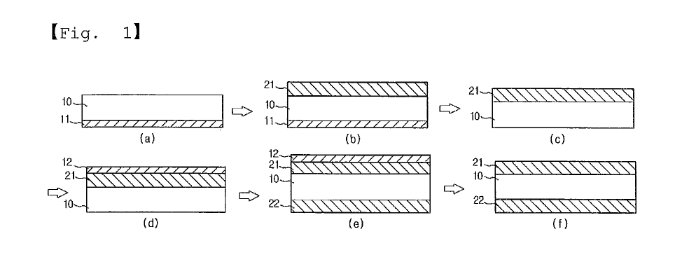

### DETAILED DESCRIPTION OF MAIN ELEMENTS

10: polymer electrolyte membrane
11: first backing film
12: second backing film
21: first catalyst layer
22: second catalyst layer

### DETAILED DESCRIPTION OF EMBODIMENTS

Hereinafter, examples will be described in detail with reference to the accompanying drawings. It is apparent that the present invention is not limited to the following examples.

### Example 1

### Preparation of Catalyst Slurry Composition

A catalyst slurry composition containing a platinum catalyst (Pt/C) supported in carbon, commercial Nafion suspension (Dupont's Nafion PFSA) as a hydrogen ions conductive binder resin, and isopropyl alcohol (IPA) solvent is prepared as shown in following Table. A content of the prepared Nafion ionomer has a 30% weight ratio based on the entire solid.

| | Content (g) | | |
|---|---|---|---|
| MEA | Pt/C | Nafion PFSA | IPA solvent |
| Example 1 | 1 | 8.6 | 10 |

### Fabrication of Membrane Electrode Assembly (MEA)

After the Nafion film (Dupont's Nafion 212), which is a commercial product as a polymer electrolyte membrane, was cut in the size of 200 mm×100 mm, a first backing film and the polymer electrolyte membrane were adhered by heating the first backing film coated with an adhesive in one surface of the film and polymer electrolyte membrane at 130° C. for 5 minutes and rolling it. Subsequently, the catalyst slurry composition was coated on the Nafion film by a doctor blade method to have a thickness of 100 μm. After hot-pressing the electrolyte membrane formed with the first catalyst layer at the conditions of 130° C. and 10 kgf/cm², the first backing film was removed. A thickness of the catalyst layer was 10 μm after drying.

A second backing film was made in the same method as the first backing film coated with the binder, and then the second backing film coating the binder to the electrolyte membrane was adhered in the same way that the first backing film and the electrolyte membrane were adhered to the first catalyst layer. Subsequently, a second catalyst layer was formed by hot-pressing in the conditions used for forming the first catalyst layer to the electrolyte membrane, and the MBA was manufactured by removing the second backing film. At this time, the platinum amount of the supported catalyst layer was 0.4 mg/cm².

What is claimed is:

1. A method for fabricating membrane electrode assembly (MEA) on a polymer electrolyte fuel cell, comprising:
adhering or fixing a first backing film to a polymer electrolyte membrane;
forming a first catalyst layer on the surface of the polymer electrolyte membrane;
removing the first backing film;
adhering or fixing a second backing film to the first catalyst layer formed on the polymer electrolyte membrane;
forming the second catalyst layer on the other side of the polymer electrolyte membrane; and
removing the second backing film to complete the MEA.

2. The method of claim 1, wherein adhesion of the first backing film to the polymer electrolyte membrane or adhesion of the second backing film to the first catalyst layer and includes a method for coating and adhering an adhesive on one surface of the first backing film and the second backing film or a fixing method by electrostatic attraction.

3. The method of claim 1, wherein in the forming of the first catalyst layer or the second catalyst layer on the surface of a polymer electrolyte membrane, drying is performed after coating an electrode catalyst slurry to the polymer electrolyte membrane.

4. The method of claim 1, wherein the first backing film and the second backing film include any one selected from a group consisting of polytetrafluoroethylene, tetrafluoroethylene-hexafluoropropylene copolymer, tetrafluoro ethylene-perfluoroalkylvinylether copolymer, ethylene/tetrafluoroethylene, polyvinylidene fluoride, polyvinyl chloride, polyimide, polyethylene, polypropylene, polyethylene terephthalate, polyester, and a copolymer thereof.

5. The method of claim 2, wherein the adhesive includes acrylic resin, silicone resin, rubber resin, urethane resin, polyester resin or epoxy resin.

6. The method of claim 3, wherein the electrode catalyst slurry composition includes a catalyst selected from a group consisting of platinum, ruthenium, osmium, platinum-ruthenium alloy, platinum-osmium alloy, platinum-palladium alloy, platinum-M alloy and a combination thereof, wherein M is a transition metal selected from a group consisting of Ga, Ti, V, Cr, Mn, Fe, Co, Ni, Cu, Zn, Sn, Mo, W, Rh and a combination thereof.

7. The method of claim 3, wherein the method for coating the electrode catalyst slurry to the polymer electrolyte membrane includes a method selected from a group consisting of a spray coating method, a screen printing method, a doctor blade method, a gravure coating method, a dip coating method, a silk printing method, a painting method, a slot die method, and a combination thereof.
